(19) United States
(12) Patent Application Publication
(10) Pub. No.: US 2019/0090430 A1
(43) Pub. Date: Mar. 28, 2019

(54) AGRICULTURAL ROUND BALER

(71) Applicant: Usines CLAAS France S.A.S., REMY/WOIPPY (FR)

(72) Inventors: CYRILLE ARNOULD, MONTOY-FLONVILLE (FR); LAURENT RONGVAUX, TRONVILLE (FR)

(73) Assignee: Usines CLAAS France S.A.S., REMY/WOIPPY (FR)

(21) Appl. No.: 16/139,655

(22) Filed: Sep. 24, 2018

(30) Foreign Application Priority Data
Sep. 26, 2017 (DE) 102017122214.6

(51) Int. Cl. A01F 15/18; A01F 15/07

(52) U.S. Cl. CPC A01F 15/18; A01F 15/07; A01F 2015/183; A01F 2015/0795; A01F 2015/078

(57) ABSTRACT

An agricultural round baler has an interior space enclosed by a housing, a feeding device, a plurality of guide rollers, a press belt and an adjusting device with at least one adjusting roller. At least one of the guide rollers is a drive roller that drives the press belt. The press belt defines a press chamber which interacts with the transfer cross section. The adjusting roller is positioned along the running track of the press belt so that at least one running track section at least partly delimits the press chamber. The adjusting roller is moveable within the interior space so that at least one part of the running track of the press belt is moveable. A second adjusting device is operationally combined with the first adjusting device to define the press chamber. The adjusting roller of the second adjusting device is moveable within the interior space.

### BACKGROUND OF THE INVENTION

The present application relates to a round baler that comprises in particular a press belt guided by means of a plurality of guide rollers, which is circulatingly mounted within an interior space of a housing of the round baler. The press belt delimits a press chamber so that material fed to the press chamber can be formed into a round bale within the press chamber.

Such a round baler is already known from the European Patent Publication EP 2 269 440 B1. The latter discloses a round baler with a so-called “variable press chamber”, which comprises an adjusting device with two adjusting rollers assigned to one another. Running track sections of the press belt directly adjoining these adjusting rollers delimit the press chamber, wherein the adjusting rollers are moveable within the interior space of the housing of the round baler by means of the adjusting device, so that a volume of the press chamber is variable. In this way, the press belt can be gradually readjusted during the course of the growing of a round bale being created, so that the round bale can be formed.

With the known round balers is has proved to be problematic to find a design that is equally suitable for different applications of a round baler. Thus, there is the desire for a round baler on the user side which on the one hand can create comparatively lightly compacted round bales. For other applications, by contrast, there is the desire to produce highly pressed or compacted round bales. The preference for the one or other version can in particular depend on the type of the pressed harvest material, its condition and/or its planned usage.

Technically, round balers whose press chamber is not variable but has a fixed cross section proved to be advantageous for producing lightly pressed round bales. This has the consequence that material to be compacted at an initial state of the round bale being created is hardly pressed since it need not be directly introduced into the press chamber against a tensioning force of a press belt. For producing highly compacted round bales by contrast, round balers with variable press chamber have proved to be advantageous in the case of which, as with the aforementioned example from the prior art—the press belt is gradually readjusted with the growing of the round bale and in this way can exert a pressing action on the harvest material even in the initial state of the round bale. In practice it now occurs frequently that a farmer has to keep different round balers in order to be equipped for a respective usage purpose.

### SUMMARY OF THE INVENTION

The present invention is thus based on the object of providing a round baler which can be employed as flexibly as possible for the various tasks for round balers.

This object is accomplished according to the invention by means of a round baler comprising an interior space enclosed by a housing, a feeding device, by means of which harvest material is feedable to the interior, a plurality of guide rollers, which extend within the interior space in a transverse direction of the round baler, a press belt, which is designed in the form of an endless belt and placed about the guide rollers in such a manner that it can circulate within the interior space along a running track, and an adjusting device, which comprises at least one adjusting roller extending parallel to the guide rollers. At least one of the guide rollers is designed in the form of a drive roller by means of which the press belt is driveable. The press belt along its running track defines a press chamber, which interacts with the transfer cross section, so that harvest material guided into the interior space by the feeding device enters the press chamber. The adjusting roller is positioned along the running track of the press belt in such a manner that at least one running track section directly following the adjusting roller (at least partly delimits the press chamber. The adjusting roller of the adjusting device is designed moveable in such a manner that at least one part of the running track of the press belt is moveable.

The “feeding device” can be formed in particular by a shaft which is equipped with radially projecting guide elements which are suitable for gripping and thereby conveying the respective harvest material in this way. The feeding device is typically arranged in a feeding channel which is arranged on a lower side of the round baler and opens into the interior space of the round baler. The feeding channel is suitable in particular for guiding respective harvest material emanating from a ground into the interior space.

The “guide rollers” typically extend in transverse direction of the round baler between side walls of the housing of the round baler located opposite one another and are generally arranged fixed within the housing. The guide rollers serve for deflecting the press belt guided along them within the interior and thereby guide the same on a desired running track.

The “transverse direction of the round baler” is orientated perpendicularly to a travelling direction of the round baler and horizontally, an axis of rotation of a respective created round bale is orientated parallel to the transverse direction of the round baler.

The press belt as such is designed in the form of an endless belt, in particular in the form of a flat endless belt. A surface of the press belt facing the harvest material to be pressed can be provided with a special surface geometry in order to be able to transmit as large as possible a friction force onto the harvest material so that by means of the movement of the press belt along the guide rollers a rotation about the center axis of the round bale can be imposed onto the same.

The adjusting device, which comprises at least one adjusting roller, is suitable for moving the running track of the press belt within the interior space of the round baler at least along a part of the running track. To this end, the adjusting roller is designed moveable, it being understood that by means of a movement of the adjusting roller within the interior space of the round baler the press belt guided via the adjusting roller is also subjected to a change in position. This principle is of central importance for round balers with variable press chamber.

In addition to the first adjusting device, the round baler according to the invention furthermore comprises a second adjusting device which equally comprises at least one adjusting roller. The second adjusting device interacts with the first adjusting device in such a manner that both jointly define the press chamber of the round baler at least in part. This means that in each case running track sections follow the adjusting rollers of the two adjusting devices which at least partly delimit the press chamber. Here, the adjusting roller of the second adjusting device just like that of the first adjusting device is moveable within the interior space of the round baler so that a change of the guidance of the running track of the press belt within the interior space can be influenced by means of both the first adjusting device and also by means of the second adjusting device.

The round baler according to the invention has many advantages. In particular it makes possible to change a geometry of the press chamber relative to the prior art. As is evident from the example of the abovementioned European patent, the press chambers of known round balers with variable press chamber generally have a triangular cross section. This is created because the press belt is guided, starting out from a fixed guide roller to the merely one adjusting device or its adjusting roller(s) known in the prior art and finally starting out from the adjusting roller of a further fixed guide roller. The fixed guide rollers in this case are generally arranged in the immediate vicinity of the transfer cross section through, starting out from the feeding channel, the harvest material to be compacted crosses into the interior space or the press chamber. Because of the three “fixed points” of the press belt along the press chamber the known triangular geometry of the same thus materializes.

The known triangular shape of a respective press chamber has as a consequence that even by means of a movement of the adjusting roller(s) by means of the adjusting device merely a conditional change of the position of the running track of the press chamber can be achieved within the interior space. Ultimately this results in that the harvest material to be pressed, is pressed against the press belt even at a very early state of the round bale being created while entering the press chamber and in the process is subjected to compaction. The triangular shape of the press chamber additionally results in that the harvest material is merely supported or pressed along two longitudinal sides of the press chamber as a result of which the bale at its initial state is given more of a triangular shape than a round shape. It is to be understood that such is not desirable for creating a round bale, it even occurring in the practice that creating a round bale fails completely since the round bale does not assume the desired rotary motion.

By means of the second adjusting device of the round baler according to the invention by contrast the geometry of the press chamber can now be configured significantly more variable wherein in particular the creation of a quadrangular cross section of the press chamber is possible. In addition, the position of the running track of the press belt within the interior space is possible by means of deflecting the press belt at a total of two moveable locations, namely at the respective adjusting roller of the adjusting device, so that the volume of the press chamber is more flexibly adjustable.

With a view to the basic object it is possible in particular to bring the adjusting devices into a position prior to the feeding of the harvest material such that the press belt defines a comparatively large press chamber. Then, harvest material fed to the press chamber need not be directly conveyed against the tension of the press belt at least at an initial state of the round bale being created so that the harvest material is initially hardly compacted. In this way, a lightly compacted round bale can be easily created if so desired. Conversely, the adjusting devices or their adjusting rollers can also be placed in such a manner that the press chamber has a very small cross section the moment harvest material is fed in for creating a new round bale, so that the harvest material within the press chamber is directly “pressed” against the press belt and is consequently subjected to high compaction. The disadvantages of an unfavorable geometry of the press chamber known in the prior art, in particular such in the form of a greatly distorted triangle, are entirely avoided in the process.

Any starting difficulties of a new round bale, as are well known in the described manner in the prior art need not be consequently expected with the round baler according to the invention. Should a round bale being created happen to get stuck in such a manner that it can no longer continue rotating within the press chamber or even does not rotate in the first place, it is additionally particularly easily possible by means of the round baler according to the invention, to change the cross section of the press chamber by moving the adjusting rollers of both adjusting devices and in this way dissolve the blockage of the round bale. In the prior art, such a moving of the adjusting rollers of the respective adjusting device has contributed comparatively little to solving the problem since the running track of the press belt was variable only to a comparatively minor degree compared with the round bale according to the invention. Following a change of the position of the adjusting rollers of both adjusting devices within the interior space, a renewed starting of the round bale can then be attempted.

A further advantage of the round baler according to the invention must be seen in that the respective round bale is now supported by a total of four “corners” within the interior space of the round baler, namely on the guide rollers fixed in place which are typically arranged on both sides of the transfer cross section and on the adjusting rollers of the adjusting devices. Because of this, the round bale in the case of the round baler according to the invention is supported in a significantly more stable manner compared with the prior art.

A further advantage of the round baler according to the invention consists in that exerting pressing pressure on the harvest material to be pressed takes place at least substantially only within the press chamber by means of the press belt, wherein running track sections of the press belt located opposite one another can mainly exert pressure forces on the round bale or the harvest material which act in opposite directions. Compared with this, the harvest material in the prior art, starting out from the feeding channel is initially pressed directly against the press belt in the moment the round bale is created, until an initial round bale is created which can then rotate within the press chamber. Thus, the feeding device in the case of the round bale according to the prior art had to have a correspondingly high conveying capacity in order to be able to press the harvest material against the tension of the press belt into the press chamber. It is exactly this which is no longer required with the round baler according to the invention since the press belt no longer blocks the entry of the harvest material into the press chamber which is attributable to the geometry of the press chamber that can be created by means of the two adjusting devices.

In an advantageous configuration of the round baler according to the invention, at least one of the adjusting devices, preferentially both adjusting devices, comprises two adjusting rollers which jointly form a roller pair. Advantageously, both adjusting rollers of an adjusting device are designed moveable. In particular, the adjusting rollers of a roller pair are arranged relative to one another such that their positions relative to one another are fixed. This means that during the course of a′ movement within the interior space of the round baler they do not perform any movement relative to one another. The configuration of a respective adjusting device with two adjusting rollers has the advantage that the press belt, which is fed to the adjusting device, can be double-deflected whereas the press belt when using merely one adjusting roller can merely be deflected once.

Advantageous, in particular, is a configuration of the round baler in which at least one of the adjusting devices, preferentially both adjusting devices, are each assigned at least one deflection roller. This deflection roller interacts with the two adjusting rollers of a respective adjusting device in such a manner that the press belt, starting out from the first adjusting roller extends to the deflection roller and from the deflection roller to the second adjusting roller. The combination of the adjusting rollers of a respective adjusting device with a deflection roller offers the advantage that on a connecting section, which extends between the deflection roller and the roller pair formed by the adjusting rollers, a press belt reserve can be kept ready in a manner of speaking, which makes possible a movement of the adjusting rollers of the respective adjusting device. In other words it is achieved that the change of the position of the adjusting rollers—and thus a change of the position of the running track of the press belt within the interior space—can be performed without the press belt having to be readjusted along its running track corresponding to the movement of the adjusting rollers. Instead, the adjusting rollers are advantageous moved quasi merely along the connecting section between the adjusting rollers and the deflection roller so that merely a deflection point of the press belt within the interior space changes, but the press belt otherwise retains its position. This applies in particular also to the remaining running rollers, which can be embodied fixed in the housing.

Further configuring the round baler according to the invention, the adjusting devices are coupled to one another so that their respective adjusting roller or adjusting rollers are moveable within the interior space synchronized with one another. In such a configuration, a change of the position of the adjusting roller of the one adjusting device is automatically accompanied by an analogous change of the position of the adjusting roller of the other adjusting device. This is particularly advantageous insofar as the press chamber, the volume of which changes during the course of the movement of the respective adjusting rollers, can be kept constant with respect to its cross-sectional shape. Thus it can be avoided that an excessive distortion of the cross-sectional shape of the press chamber occurs which in turn could be unfavorable for creating a round bale.

Particularly advantageous, furthermore, can be such a round baler in which the transfer cross section extends between two guide rollers extending parallel to the transverse direction of the round baler. Such a transfer cross section advantageously lies in a plane which contains the center axes of these two guide rollers. With a round baler embodied in this manner, the press chamber is typically defined by means of a total of four deflection points, namely the two abovementioned guide rollers and the two adjusting devices or their adjusting rollers.

By means of the mentioned configuration it is particularly easily possible to define a quadrangular press chamber, wherein the press belt advantageously extends starting out from a first guide roller, initially to the first adjusting device, then to the second adjusting device and finally to the second guide roller. Otherwise, the press belt is guided within the interior space of the round baler by means of further guide rollers in such a manner that a collision with a round bale being created is excluded. The advantages of a quadrangular press chamber have already been explained above. In particular, acute angles at deflection points of the press belt are particularly easily avoidable as a result of which the formation of a round bale is simplified. In addition, exerting a pressing force on the harvest material to be pressed can be advantageously performed at a plurality of sides of the round bale so that the force effect on the harvest material is evened out on the whole.

Further advantageously, the quadrangular press chamber is formed in such a manner that—viewed in a cross section—it is delimited on three of its sides by means of the press belt and in its fourth side comprises the transfer cross section. With such a press chamber it is particularly easily possible to introduce the harvest material to be pressed into the press chamber by means of a comparatively low conveying output and only subsequently press the same to form the round bale within the press chamber. This embodiment allows a smaller dimensioning of the feeding device since the same does not have to generate a high conveying output for conveying the harvest material against the tension of a respective press belt as is usual in the prior art.

With respect to the cross section of the press chamber a trapezium shape is preferable in particular, wherein such a press chamber advantageously expands, preferentially symmetrically, starting out from the transfer cross section. Here, the symmetry further preferentially exists with respect to a center plane which is orientated perpendicularly to the transfer cross section and parallel to a longitudinal direction of the transfer cross section or transverse direction of the round baler and is located in the center at the transfer cross section. Ideally, the press chamber is thus designed symmetrically in such a manner that the center point of the respective round bale continuously lies at least substantially in the center plane during its creation irrespective of its radius. A press chamber formed symmetrically in this way is preferable with respect to as uniform as possible a force effect on the round bale being created.

Further configuring the round bale according to the invention, at least one of the adjusting devices, preferentially both adjusting devices, comprise at least one linear drive by means of which the adjusting rollers of the roller pair of the respective adjusting device are moveable within the interior space of the round baler along a straight line. This straight line advantageously extends between the adjusting rollers or the roller pair and the fixed deflection roller associated with this. This has the consequence that by means of a movement of the adjusting rollers of a respective adjusting device merely a distance between the adjusting rollers and the associated deflection roller is changed, wherein the adjusting rollers are ultimately guided along the running track of the press belt which extends between the adjusting rollers and the deflection roller. During the course of this, the running track sections of the press belt, which immediately follow the adjusting rollers, are moved so that the volume and/or the geometry of the press chamber change/s.

Preferentially, the linear drive of the adjusting device or adjusting devices formed in this way can comprise a piston-cylinder unit. Here it is conceivable, in particular, that a deflection roller is arranged on a fixed cylinder of the piston-cylinder unit, while the adjusting rollers are located at an end of the moveable piston of the piston-cylinder unit facing away from the cylinder. In this way, the adjusting rollers can be moved particularly easily by moving the piston within the cylinder.

### BRIEF DESCRIPTION OF THE DRAWINGS

In the following, the round baler according to the invention is explained in more detail by way of exemplary embodiments shown in the figures. It shows:

FIG. 1: a round baler according to the prior art,

FIG. 2: a schematic sketch of a guiding arrangement of a press belt of a round baler according to the invention,

FIG. 3: a schematic sketch of the guiding arrangement of the press belt according to FIG. 2, wherein a volume of a press chamber is changed relative to a state shown in FIG. 2, and

FIG. 4: a schematic sketch of a guiding arrangement of a press belt of a further round baler according to the invention.

### DETAILED DESCRIPTION OF THE PREFERRED EMBODIMENTS

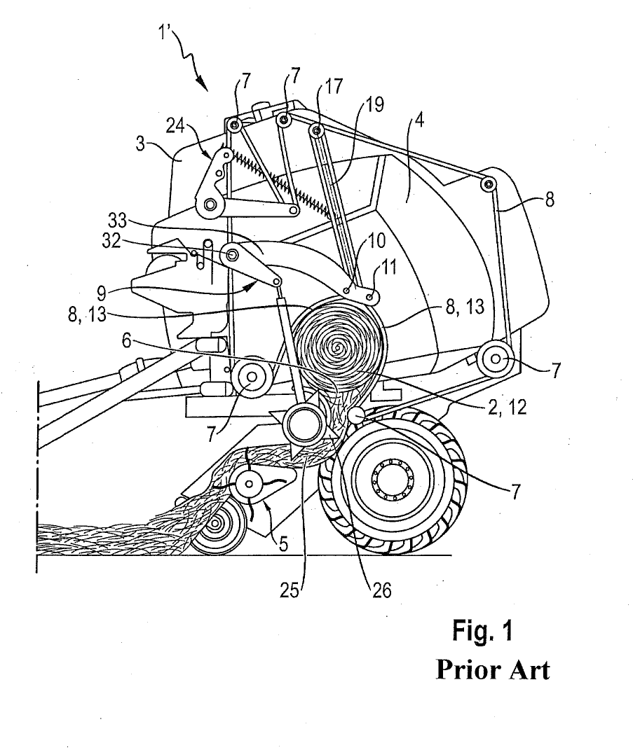

A first exemplary embodiment, which is shown in FIG. 1, comprises a round baler 1′ according to the prior art. This in turn comprises a housing 3, which has an interior space 4, and a press chamber 12 which within the interior space 4 is delimited by means of a press belt 8, within which press chamber 12 a round bale 2 just happens to be pressed in the state shown in FIG. 1. The press belt 8 is guided within the interior space 4 by means of a plurality of guide rollers 7, wherein one of the guide rollers 7 is embodied as drive roller. In this way, the press belt 8 which is endless and flat in itself is continuously moveable about the guide rollers 7. The latter extend parallel to a transverse direction of the round baler 1′.

The known round baler 1′ comprises a feeding device 5 which is designed in the form of a rotating shaft. The same is equipped with four conveying elements extending radially from an outer lateral surface of the shaft so that the feeding device 5 during the course of its rotation can convey harvest material in the direction of the interior space 4 of the round baler 1′. In the process, the harvest material is guided through a feeding channel 25, wherein in the shown example the harvest material, prior to passing from the feeding channel 25 into the press chamber 12, is reduced in size by means of a cutting device 26. Finally, the harvest material passes through a transfer cross section 6 into the press chamber 12.

The latter is delimited downwards by the transfer cross section 6 and upwards and sideways by the press belt 8. In order to be able to suitably readjust the press belt 8 during the course of the growing of the round bale 2, the round baler 1′ comprises an adjusting device 9. The same comprises a pivot arm 33, which is pivotably mounted about a pivot axis 32. At an end of the pivot arm 33 facing away from the pivot axis 32, the adjusting device 9 comprises two adjusting rollers 10, 11. These are moveable within the interior space 4 during the course of a pivoting of the pivot arm 33 about its pivot axis 32, so that a deflection of the press belt 8 brought about by means of the adjusting rollers 10, 11 is equally moveable. The adjusting device 9 in this case interacts with a deflection roller 17 associated with the adjusting rollers 10, 11, which is arranged spaced from the adjusting rollers 10, 11. Here, the press belt is embodied in such a manner that starting out from the first adjusting roller 10 it extends to the deflection roller 17 and then from the deflection roller 17 to the second adjusting roller 11. A movement of adjusting rollers 10, 11 during the course of the pivoting of the pivot arm 33 takes place at least approximately along a connecting track 19 formed straight, which connects the roller pair formed by the adjusting rollers 10, 11 with the deflection roller 17. Furthermore, the round baler 1′ interacts with a tensioning device 24, which tensions the press belt 8 under the effect of a spring force.

As is particularly readily visible by means of the representation according to FIG. 1, the press chamber 12 of the round baler 1′ is defined by means of the action of three deflection points. These are formed by the deflection rollers 7 arranged laterally next to the transfer cross section 6 and the roller pair formed by the adjusting rollers 10, 11. The deflection of the press belt 8 at these three deflection points causes a triangular-shaped press chamber 12 to be defined. This triangular cross section of the press chamber 12 is accompanied by the disadvantages presented at the outset. In particular, the shown round baler 1′ according to the prior art is not suitable for creating lightly compacted round bales 2.

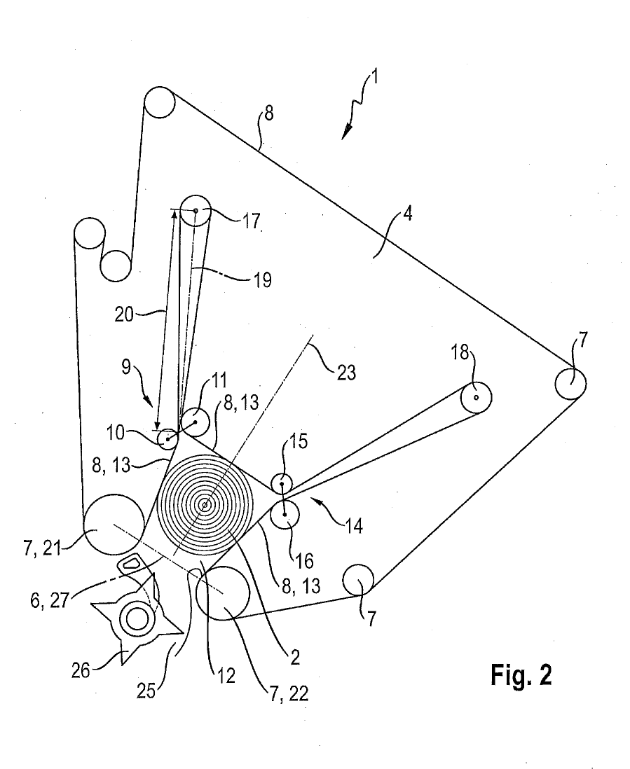

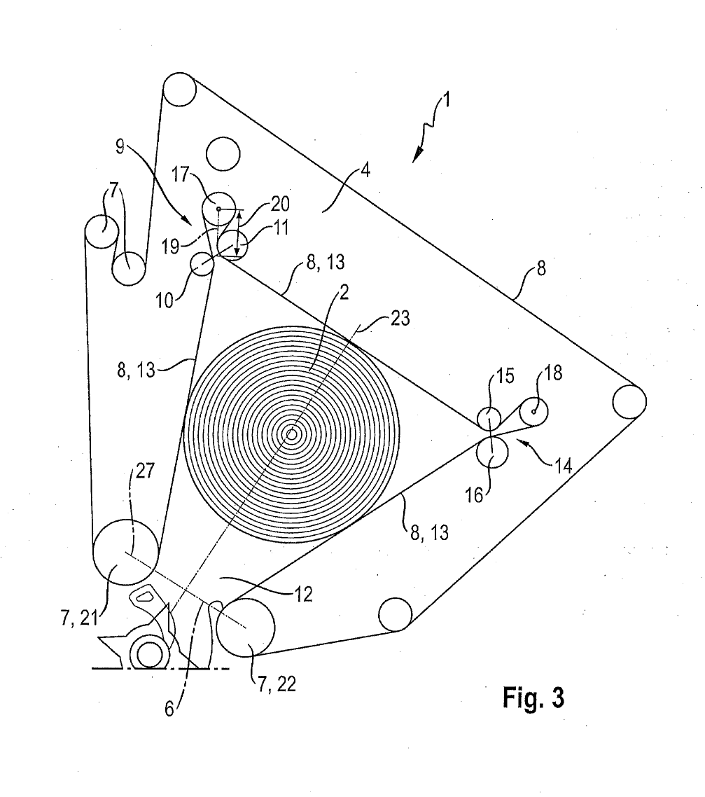

A further exemplary embodiment, which is shown in the FIGS. 2 and 3, by contrast, describes a round baler 1 according to the invention. In contrast with the known round baler 1′, the same is equipped with two adjusting devices 9, 14, which are exemplarily equipped here with two adjusting rollers 10, 11, 15, 16 in each case. The additional adjusting device 14 creates a further deflection point for the press belt 8, so that by means of the two guide rollers 21, 22 arranged laterally of the transfer cross section 6 and the two adjusting devices 9, 14 a quadrangular press chamber 12 is defined. In the shown example, the transfer cross section 6 is situated on a plane 27 which includes the axes of rotation of the two guide rollers 21, 22, which delimit the transfer cross section 6 on both sides. Furthermore, the press chamber 12 is designed trapezoid-shaped in the shown example, while the press chamber 12 is formed symmetrically in a center plane 23. This center blade 23 is oriented perpendicularly to the transfer cross section 6 and parallel to the transverse direction of the round baler 1 and arranged in the center at the transfer cross section 6. The trapezium shape of the press chamber 12 is configured in such a manner that a cross section of the press chamber 12 measured perpendicularly to the center plane gradually expands starting out from the transfer cross section 6. This symmetrical configuration of the press chamber 12 with regard to the center plane 23 results in that an axis of rotation of the respective round bale 2 being created typically lies at least substantially in the center plane 23.

In the shown example, the adjusting devices 9, 14 each interact with a deflection roller 17, 18. These are arranged in such a manner that the press belt 8, starting out from a first adjusting roller 10, 15 of the respective adjusting device 9, 14 initially extends to the respective associated deflection roller 17, 18 and then, starting out from the deflection roller 17, 18, to the respective second adjusting roller 11, 18. The adjusting rollers 10, 11, 15, 16 of the two adjusting devices 9, 14 assigned to one another are each located at a distance 20 from their respective associated deflection roller 17, 18. The adjusting rollers 10, 11, 15, 16 are formed moveable within the interior space 4 of the round baler 1 in such a manner that they are moveable along a connecting section 19 relative to the associated deflection roller 17, 18. This has the consequence that running track sections 13 of the press belt 8 directly following the connecting rollers 10, 11, 12, 16 are equally moveable within the interior space 4. The result of a corresponding movement of the adjusting rollers 10, 11, 15, 16 including a movement of the mentioned running track sections 13 of the press belt 8 accompanied by this is particularly clearly evident in the comparison of the states of the round baler 1 according to the invention shown in the FIGS. 2 and 3. In particular it shows that a distance 20 is changed between a respective roller pair of the adjusting rollers 10, 11, 15, 16 and the respective associated deflection rollers 17, 18. This is attributable to the movement of the respective adjusting rollers 10, 11, 15, 16 along the connecting track 19.

In the shown example, the movement of the adjusting rollers 10, 11, 15, 16 or the adjustment of the two adjusting devices 9, 14 starting out from the state shown in FIG. 2 to the state shown in FIG. 3 has taken place synchronously so that the press chamber as a whole has retained its symmetrical and trapezium-shaped geometry. Thus, the axis of rotation of the round bale 2 being created continues to lie at least approximately in the center plane 23. In the state shown in FIG. 3, the round bale 2 is almost completed while a volume of the press chamber 12 can hardly be enlarged any longer since the adjusting rollers 10, 11, 15, 16 of the adjusting devices 9, 14 are already located at an almost minimal distance 20 to the associated deflection rollers 17, 18.

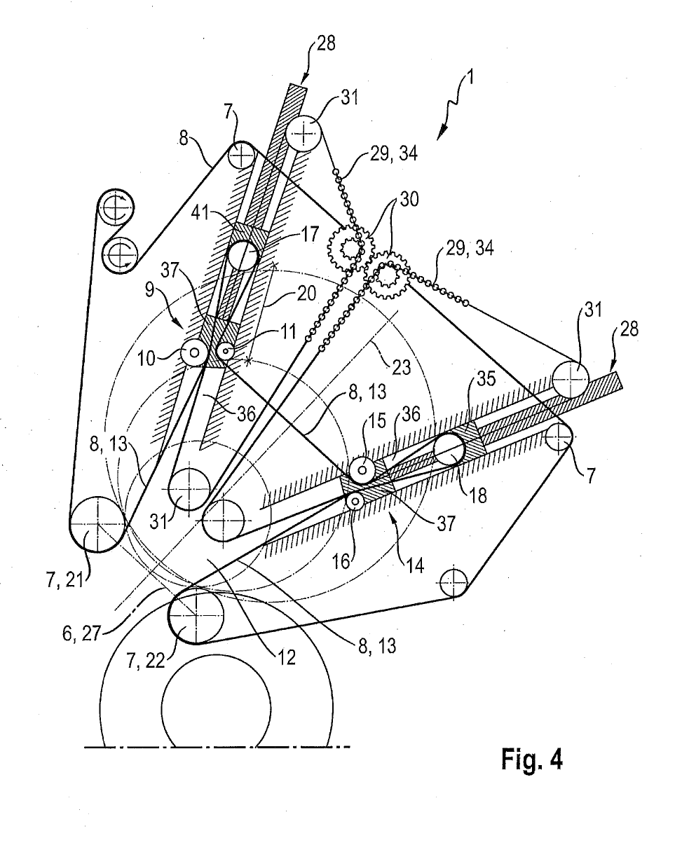

In a further exemplary embodiment shown in FIG. 4 the manner in which the adjusting devices 9, 14 can be designed as illustrated in order to be able to create an in particular synchronous movement of the adjusting rollers 10, 11, 15, 16 assigned to them. Initially, the adjusting devices 9, 14 are each equipped in the shown example with a linear drive 28 comprising a piston-cylinder unit. The adjusting rollers 10, 11, 15, 16 of the adjusting devices 9, 14 are each arranged on an associated guide carriage, which is moveable within a guide channel 36 by means of the linear drive 28. Furthermore, the respective deflection rollers 17, 18 assigned to the adjusting devices 9, 14 are equally located on a support carriage 35, which is arranged fixed in place within the guide channel 36. By means of an actuation of the linear drive 28 a piston of the same, on which the guide carriage 37 of the respective adjusting device 9, 14 is arranged, is moved within the guide channel as a result of which the distance 20 of the roller pair formed by the respective adjusting rollers 10, 11, 15, 16 from the associated deflection roller 17, 18 is changed.

The guide carriage 37 of a respective adjusting device 9, 14 is coupled at both its ends to a traction chain 29 within the guide channel 36. Said traction chain 29 is guided in a circulation by means of deflection rollers 31 and a gearing 30 so that a movement of the guide carriage 37 within the guide channel 36 is accompanied by a corresponding movement of the traction chain 29 about the deflection rollers 31 and in particular about the gearing 30. For this purpose, the traction chain 29 comprises an engagement region 34 which is suitable for interacting with a complementary toothing of the gearing 30. This results in that a movement of the traction chain 29 is directly translated into a rotation of the gearing 30.

As is particularly clearly evident from the representation according to FIG. 4, the adjusting devices 9, 14 and the described associated traction chain mechanism are exemplarily formed symmetrically here, wherein both adjusting devices 9, 14 are each connected with a gearing 30 via a respective associated traction chain 29. The gearings 30 each have an outer tooth rim by means of which the same intermesh so that a rotation of the one gearing 30 invariably leads to a corresponding rotation of the respective other gearing 30. It is to be understood that the rotation of a respective gearing 30 in turn is accompanied by a movement of the traction chain 29 and consequently by a corresponding movement of the guide carriage 37 and the adjusting rollers 10, 11, 15, 16 arranged thereon. Accordingly, it is ensured by means of the shown embodiment that the guide carriages 37 of the two adjusting devices 9, 14 synchronously move towards one another in every case. This in turn results in that a change of the cross section and of the volume of the press chamber 12 takes place symmetrically, so that the press chamber 12 is continuously formed symmetrically relative to the center plane 23.

### REFERENCE LIST

1 Round baler
2 Round bale
3 Housing
4 Interior space
5 Feeding device
6 Transfer cross section
7 Guide roller
8 Press belt
9 Adjusting device
10 Adjusting roller
11 Adjusting roller
12 Press chamber
13 Running track section
14 Adjusting device
15 Adjusting roller
16 Adjusting roller
17 Deflection roller
18 Deflection roller
19 Connecting section
20 Distance
21 Guide roller
22 Guide roller
23 Center plane
24 Tensioning device
25 Feeding channel
26 Cutting device
27 Plane
28 Linear drive
29 Traction chain
30 Gearing
31 Deflection roller
32 Pivot axis
33 Pivot arm
34 Engagement region
35 Support carriage
36 Guide channel
37 Guide carriage

What is claimed is:

1. An agricultural round baler for pressing stalk-like harvest material into round bales, comprising:
an interior space enclosed by a housing,
a feeding device, by means of which harvest material is feedable to the interior space through a transfer cross section,
a plurality of guide rollers, which extend within the interior space in a transverse direction of the round baler,
a press belt, which is designed in the form of an endless belt and placed about the guide rollers in such a manner that the press belt can circulate within the interior space along a running track,
an adjusting device, which comprises at least one adjusting roller extending parallel to the guide rollers, and
at least one second adjusting device, the adjusting roller of which operatively combined with the adjusting roller of the first adjusting device at least partly defines the press chamber,
wherein at least one of the guide rollers is designed in the form of a drive roller that is configured for driving the press belt,
wherein the press belt along its running track defines a press chamber, which interacts with the transfer cross section so that harvest material guided into the interior space by the feeding device enters the press chamber,
wherein the adjusting roller is positioned along the running track of the press belt in such a manner that at least one running track section directly following the adjusting roller at least partly delimits the press chamber,
wherein the adjusting roller of the adjusting device is designed moveable in such a manner that at least one part of the running track of the press belt is moveable, and
wherein the adjusting roller of the second adjusting device is designed moveable so that at least one part of the running track of the press belt is moveable within the interior space.

2. The round baler according to claim 1, wherein at least one of the adjusting devices has a roller pair which comprises two adjusting rollers assigned to one another, and wherein both adjusting rollers are designed to be moveable.

3. The round baler according to claim 2, wherein the adjusting rollers of the respective adjusting device are fixed relative to one another so that a relative position of the adjusting rollers remains unchanged during a course of movement of the adjusting rollers within the interior space.

4. The round baler according to claim 2, wherein at least one of the adjusting devices is assigned at least one deflection roller which interacts with the adjusting rollers of the at least one adjusting device so that the press belt starting from the first adjusting roller extends to the deflection roller and from the deflection roller to the second adjusting roller.

5. The round baler according to claim 4, wherein the adjusting rollers are moveable along a connecting track between the adjusting rollers and the deflection roller assigned to the adjusting rollers, so that a distance between the adjusting rollers and the deflection roller changes.

6. The round baler according to claim 1, wherein the two adjusting devices are coupled to one another so that their adjusting rollers are moveable within the interior space in synchronization.

7. The round baler according to claim 1, wherein the transfer cross section extends between two guide rollers extending parallel to the transverse direction of the round baler, wherein the transfer cross section lies in a plane, which includes the center axes of the two guide rollers.

8. The round baler according to claim 7, wherein the two guide rollers delimiting the transfer cross section jointly with both adjusting devices define a quadrangular press chamber when viewed in a cross section of the round baler, and wherein the press belt starting from a first guide roller initially extends to the first adjusting device, thereafter to the second adjusting device and finally to the second guide roller.

9. The round baler according to claim 8, wherein the press chamber when viewed in cross section is delimited on three of sides by the press belt and at a fourth side comprises the transfer cross section.

10. The round baler according to claim 8, wherein the press chamber is in the shape of a trapezoid, and wherein the press chamber expands starting out from the transfer cross section.

11. The round baler according to claim 7, wherein the press chamber is designed symmetrically with respect to a center plane that is orientated perpendicularly to the transfer cross section and located in the middle at the transfer cross section.

12. The round baler according to claim 2, wherein at least one of the adjusting devices comprises at least one linear drive, so that the adjusting rollers are moveable within the interior space along a straight line, and wherein the straight line extends between the adjusting rollers and a fixed deflection roller assigned to the adjusting rollers.

13. The round baler according to claim 12, wherein the linear drive comprises a piston-cylinder unit.
